(19) United States
(12) Patent Application Publication
(10) Pub. No.: US 2013/0253840 A1
(43) Pub. Date: Sep. 26, 2013

(54) PROCESSING TECHNIQUE FOR AN IMPEDANCE BIOSENSOR

(71) Applicant: Dean MESSING, Camas, WA (US)

(72) Inventor: Dean MESSING, Camas, WA (US)

(73) Assignee: SHARP LABORATORIES OF AMERICA, INC., Camas, WA (US)

(21) Appl. No.: 13/430,307

(22) Filed: Mar. 26, 2012

(51) Int. Cl. G06F 19/00

(52) U.S. Cl. 702/19

(57) ABSTRACT

A system for determining impedance includes receiving a time varying voltage signal from a biosensor and receiving a time varying current signal from the biosensor. The time varying voltage signal and the time varying current signal are transformed to a domain that represents complex impedance values. Calculating parameters based upon the impedance values in a manner suitable to automatically select a first endpoint of an analysis aperture in a region of interest.

### CROSS-REFERENCE TO RELATED APPLICATIONS

None.

### BACKGROUND OF THE INVENTION

The present invention relates generally to signal processing for a biosensor.

A biosensor is a device designed to detect or quantify a biochemical molecule such as a particular DNA sequence or particular protein. Many biosensors are affinity-based, meaning they use an immobilized capture probe that binds the molecule being sensed—the target or analyte—selectively, thus transferring the challenge of detecting a target in solution into detecting a change at a localized surface. This change can then be measured in a variety of ways. Electrical biosensors rely on the measurement of currents and/or voltages to detect binding. Due to their relatively low cost, relatively low power consumption, and ability for miniaturization, electrical biosensors are useful for applications where it is desirable to minimize size and cost.

Electrical biosensors can use different electrical measurement techniques, including for example, voltammetric, amperometric/coulometric, and impedance sensors. Voltammetry and amperometry involve measuring the current at an electrode as a function of applied electrode-solution voltage. These techniques are based upon using a DC or pseudo-DC signal and intentionally change the electrode conditions. In contrast, impedance biosensors measure the electrical impedance of an interface in AC steady state, typically with constant DC bias conditions. Most often this is accomplished by imposing a small sinusoidal voltage at a particular frequency and measuring the resulting current; the process can be repeated at different frequencies. The ratio of the voltage-to-current phasor gives the impedance. This approach, sometimes known as electrochemical impedance spectroscopy (EIS), has been used to study a variety of electrochemical phenomena over a wide frequency range. If the impedance of the electrode-solution interface changes when the target analyte is captured by the probe, EIS can be used to detect that impedance change over a range of frequencies. Alternatively, the impedance or capacitance of the interface may be measured at a single frequency.

What is desired is a signal processing technique for a biosensor.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a biosensor system for medical diagnosis.

FIG. 2 illustrates a noisy impedance signal and impedance model.

FIG. 3 illustrates a one-port linear time invariant system.

FIGS. 4A and 4B illustrate different pairs of DTFT functions.

FIG. 5 illustrates noisy complex exponentials.

FIG. 6 illustrates transmission zeros and poles.

FIG. 7 illustrates a noisy signal and true signal.

FIG. 8 illustrates multiple repetitions of FIG. 7.

FIGS. 9A and 9B illustrate accuracy for line fitting.

FIG. 10 illustrates an impedance graph.

FIG. 11 illustrates groups of specific binding and non-specific binding.

FIG. 12 illustrates aligned impedance responses.

FIG. 13 illustrates low concentration impedance response curves.

FIG. 14 illustrates estimation of analyte concentration.

FIG. 15 illustrates another estimation technique.

FIG. 16 illustrates yet another estimation technique.

FIG. 17 illustrates an exemplary impedance biosensor signal.

FIG. 18 illustrates five impedance responses.

FIG. 19 illustrates parameter variations with the responses of FIG. 18.

FIG. 20 illustrates five ideal noisy exponential impedance responses.

FIG. 21 illustrates instantaneous variations of s₁ across one impedance response.

FIG. 22 illustrates an instantaneous sample mean, standard error of the profiles of FIG. 18.

FIG. 23 illustrates five impedance responses for a positive target.

FIG. 24 illustrates an expanded region of interest of FIG. 23.

FIG. 25 illustrates five provides, a sample mean, and a standard error.

FIG. 26 illustrates left endpoint estimations.

FIG. 27 illustrates an ideal impedance response.

FIG. 28 illustrates the result of successively applying a parameter estimation technique to the ideal response.

### DETAILED DESCRIPTION OF PREFERRED EMBODIMENT

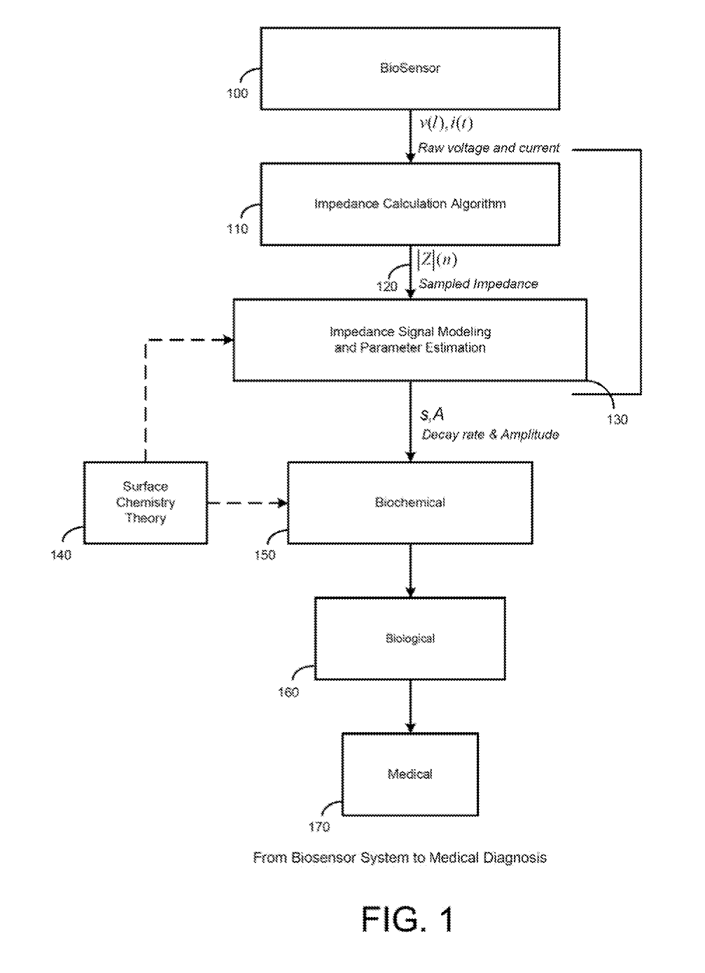

Referring to FIG. 1, the technique used during an exemplary medical diagnostic test using an impedance biosensor system as the diagnostic instrument is shown. The system includes a bio-functionalized impedance electrode and data acquisition system 100 for the signal acquisition of the raw stimulus voltage, v(t), and response current, i(t). Next, an impedance calculation technique 110 is used to compute sampled complex impedance, Z(n) as a function of time.

As illustrated in FIG. 1, the magnitude of the complex impedance, |Z(n)|, is shown as the output of the impedance calculation technique 110. Preferably, a parameter estimation technique 130 uses |Z|(n) 120 as its input. Real or imaginary parts, or phase of Z are also possible inputs to the parameter estimation technique 130. Following the computation of |Z|(n) 120, the parameter estimation technique 130 extracts selected parameters. Such parameters may include, for example, an amplitude “A”, and decay rate “s”. The amplitude and decay rate may be modeled according to the following relation:

|Z(n)|=B−Ae^{-sn} where s, A, B≧0 are preferably constants (equation 1),

derived from surface chemistry interaction 140. The constant B preferably represents the baseline impedance which may also be delivered by the parameter estimation technique. The surface chemistry theory 140 together with the results of the parameter estimation 130 may be used for biochemical analysis 150. The biochemical analysis 150 may include, for example, concentration, surface coverage, affinity, and dissociation. The result of the biochemical analysis 150 may be used to perform biological analysis 160. The biological analysis 160 may be used to determine the likely pathogen, how much is present, whether greater than a threshold, etc. The biological analysis 160 may be used for medical analysis 170 to diagnosis and treat.

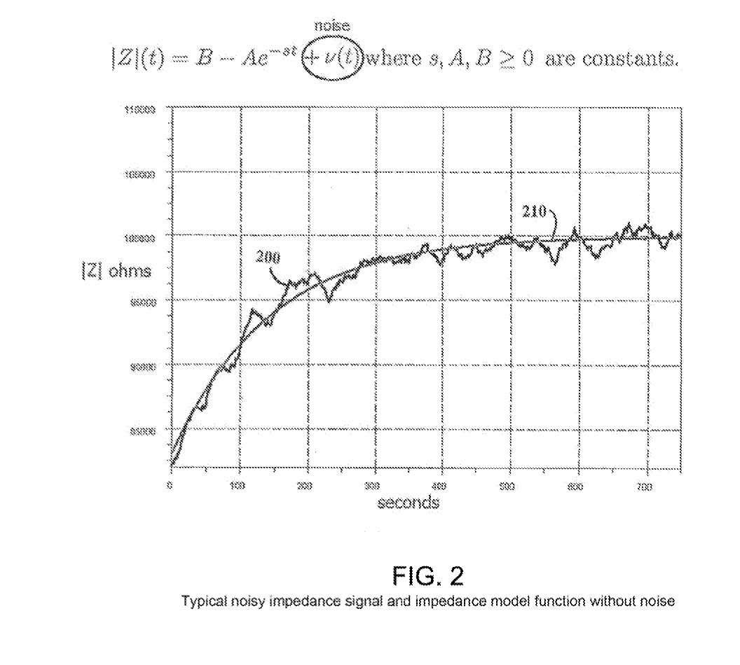

Referring to FIG. 2, an exemplary noisy impedance signal 200 is shown during analyte binding. The parameter estimation 130 receives such a signal as an input and extracts s, A, and B. From these three parameters, an estimate of the underlying model function may be computed from equation 1 using the extracted parameters. Such a model function is shown by the smooth curve 210 in FIG. 2. One of the principal difficulties in estimating these parameters is the substantial additive noise present in the impedance signal 200.

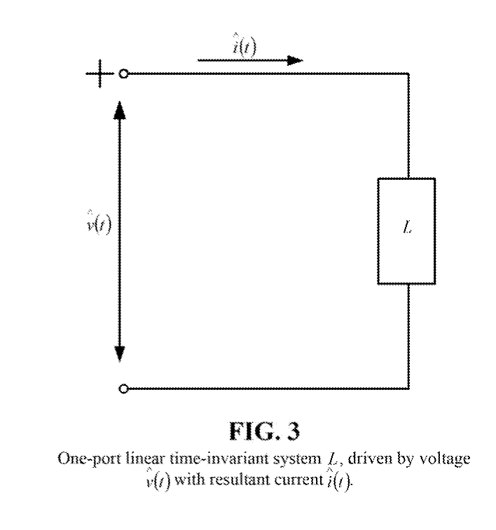

Over relatively short time periods, such as 1 second or less, the system may consider the impedance of the biosensor to be in a constant state. Based upon this assumption, it is a reasonable to approximate the system by a linear time invariant system such as shown in FIG. 3. Variables with a “hat” are complex valued, while the complex impedance is noted as Z. In some embodiments, for example, the system may be non-linear, time variant, or non-linear time variant.

One may presume that FIG. 3 is driven by the complex exponential voltage \hat{v}(t)=Âᵥ e^{jw}^{₀}^{t} (equation 2) where Âᵥ is a complex number known as the complex amplitude of v(t), and ω₀ is the angular frequency of v(t) in rad/sec. The current through L will, again, be a complex exponential having the same angular frequency î(t)=Âᵢ e^{jw}^{₀}^{t} (equation 3) where Âᵢ is the complex amplitude of î(t). The steady-state complex impedance Z of L at angular frequency ω₀ is defined to be the quotient \hat{v}(t)/î(t) when the driving voltage or current is a complex exponential of frequency ω₀. This definition does not hold for ordinary real-valued “physical” sinusoids. This may be observed, for example, from the fact that the denominator of v(t)/i(t) would periodically vanish if v(t) and i(t) are sine curves. Denoting Âv=Aᵥ e^{jφ} and Âᵢ=Aᵢ e^{jθ}, where Aᵥ=|Âᵥ| and Aᵢ=|Âᵢ| then Z becomes

$$Z = \frac{{A}_{v}}{{A}_{i}} {e}^{j ( φ - θ )} . \qquad ( equation 4 )$$

The impedance biosensor delivers sampled voltage and current from the sensor. It is noted that the sinusoidal (real-valued) stimulus voltage and response current can each be viewed as the sum of two complex exponential terms. Therefore to estimate the complex voltage and the complex current for calculating Z, the system may compute the discrete-time-Fourier-transform (“DTFT”) of each, where the DTFT of each is evaluated at a known stimulus frequency. If the stimulus frequency is not known, it may be estimated using standard techniques. Unfortunately, the finite time aperture of the computation and the incommensurability of the sampling frequency and the stimulus frequency can corrupt the estimated complex voltage and current values.

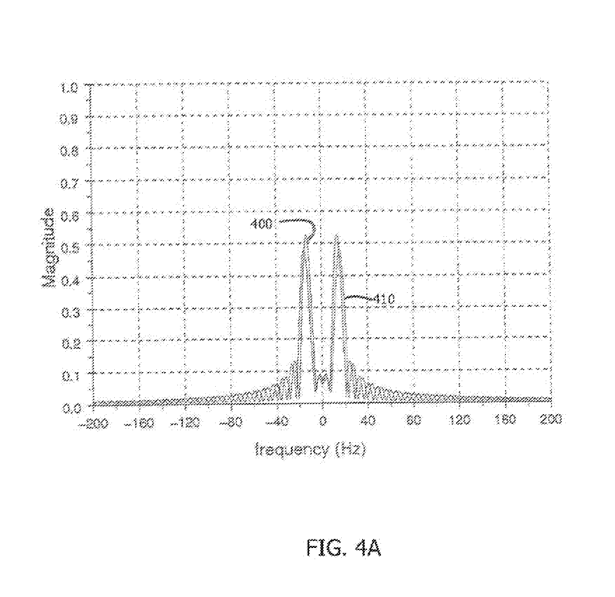

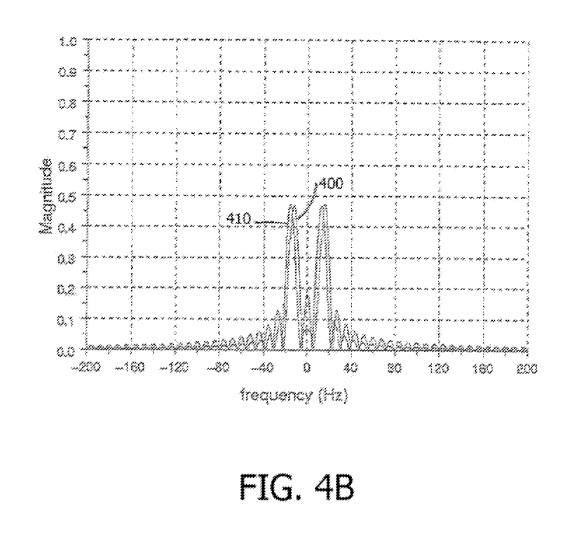

An example of these effects are shown in FIGS. 4A and 4B where the DTFT of two sinusoids having different frequencies and phases, but identical (unit) amplitudes are plotted. FIG. 4A illustrates a plot of the DTFT of a 17 Hz sinusoid 400 and a 19 HZ sinusoid 410. Each has the same phase, ψ. FIG. 4B illustrates a shifted phase of each to a new value ψ≠φ. It may be observed that the peak amplitudes of the DTFTs are different in one case and nearly the same in the other, yet the actual amplitudes of the sinusoids are unity in all cases.

A correction technique is used to determine the “true” value of the underlying peak from the measured value of the positive frequency peak together with the contribution of the negative frequency peak weighted by a value, such as the Dirichlet Kernel function associated with the time aperture. The result is capable of giving the complex voltage and current estimated values within less than 0.1% of their “true” values. Once the estimates of \hat{v} and î are found, Z is computed as previously noted.

The decay rate estimation technique may use any suitable technique. The preferred technique is a modified form of the general Kumaresan-Tufts (KT) technique to extract complex frequencies. In general, the KT technique assumes a general signal model composed of uniformly spaced samples of a sum of M complex exponentials corrupted by zero-mean white Gaussian noise, w(n), and observed over a time aperture of N samples. This may be described by the equation

$$y ( n ) = {\sum }_{k = 1}^{M} {α}_{k} {e}^{{β}_{k} n} + w ( n ) \\ n = 0 , 1 , … , N - 1. \qquad ( equation 5 )$$

βₖ=−sₖ+i2πfₖ are complex numbers (sₖ is non-negative) and αₖ are the complex amplitudes. The {βₖ} may be referred to as the complex frequencies of the signal. Alternatively, they may be referred to as poles. {sₖ} may be referred to as the pole damping factors and {fₖ} are the pole frequencies. The KT technique estimates the complex frequencies {βₖ} but not the complex amplitudes. The amplitudes {αₖ} are later estimated using any suitable technique, such as using Total Least Squares once estimates of the poles y(n) are obtained.

The technique may be summarized as follows.
(1) Acquire N samples of the signal, {y*(n)}ₙ₌₀^{N-1} to be analyzed, where y is determined using equation 5.
(2) Construct a L^{th} order backward linear predictor where M≦L≦N≦M:
   (a) Form a (N−L)×L Henkel data matrix, A, from the conjugated data samples {y*(n)}ₙ₌₁^{N-1}.
   (b) Form a right hand side backward prediction vector h=[y(0), . . . , y(N−L−1)]^{H} (A is the conjugate transpose).
   (c) Form a predictor equation.
      Ab=−h, where b=[b(1), . . . , b(L)]^{T} are the backward prediction filter coefficients. It may be observed that the predictor implements an L^{th} order FIR filter that essentially computes y(0) from y(1), . . . , y(N−1).
   (d) Decompose A into its singular values and vectors: A=UΣV^{H}.
   (e) Compute b as the truncated SVD solution Ab=−h where all but the first M singular values (ordered from largest to smallest) are set to zero. This may also be referred to as the reduced rank pseudo-inverse solution.
   (f) Form a complex polynomial B(z)=1+Σₗ₌₁^{L} b(l)^{l} which has zeros at {e^{-B}^{ₖ}^{*}}ₖ₌₁^{M} among its L complex zeros. This polynomial is the z-transform of the backward prediction error filter.
   (g) Extract the L zeros, {zₗ}ₗ₌₁^{L}, of B(z)
   (h) Search for zeros, Zₗ, that fall outside or on the unit circle (1≦|zₗ|). There will be M such zeros. These are the M signal zeros of B(z), namely {e^{-B}^{ₖ}^{*}}ₖ₌₁^{M}. The remaining L-M zeros are the extraneous zeros. The extraneous zeros fall inside the unit circle.
   (i) Recover sₖ and 2πfₖ from the corresponding zₖ by computing Re[ln (zₖ)] and Im[ln (zₖ)], respectively.

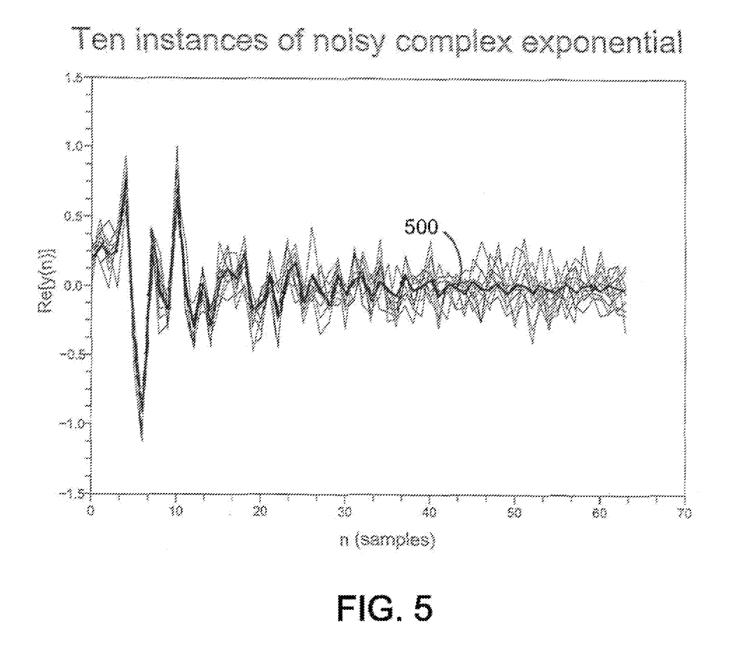

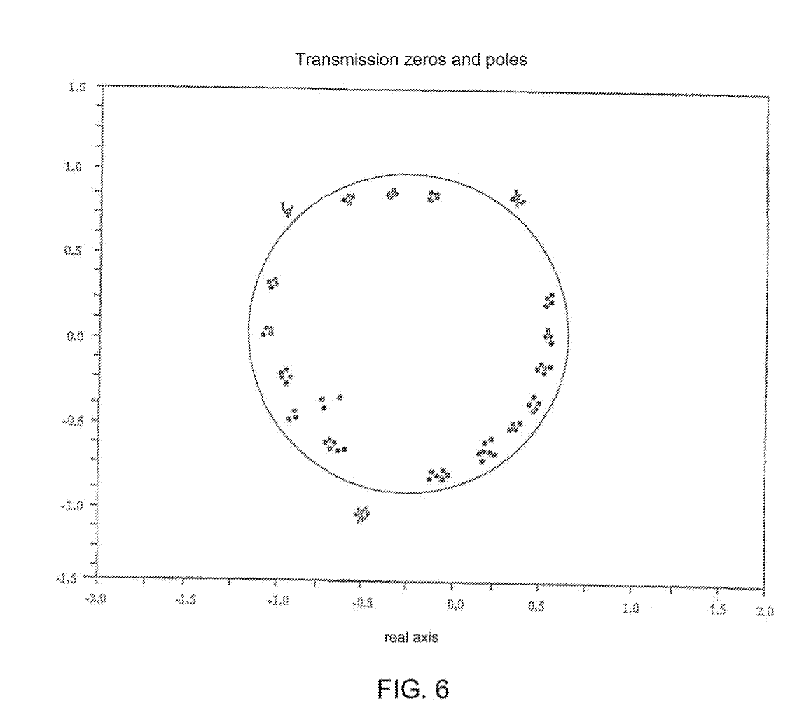

Referring to FIG. 5 and FIG. 6, one result of the KT technique is shown. The technique illustrates 10 instances of a 64-sample 3 pole noisy complex exponential. The noise level was set such that PSNR was about 15 dB. FIG. 5 illustrates the real part of ten signal instances. Overlaid is the noiseless signal 500.

FIG. 6 illustrates the results of running the KT technique on the noisy signal instances of FIG. 5. These results were generated with the following internal settings N=64, M=3, and L=18. The technique estimated the three single pole positions relatively accurately and precision in the presence of significant noise. As expected, they fall outside the unit circle while the 15 extraneous zeros fall inside.

As noted, the biosensor signal model defined by equation 1 accords with the KT signal model of equation 5 where M=2, β₁=0, β₂=−s. In other words, equation 1 defines a two-pole signal with one pole on the unit circle and the other pole on the real axis just to the right of (1,0).

On the other hand, typical biosensor impedance signals can have decay rates that are an order of magnitude or more smaller than those illustrated above. In terms of poles, this means that the signal pole location, s, is nearly coincident with the pole at (1,0) which represents the constant exponential term B.

The poles may be more readily resolved from one another by substantially sub-sampling the signal to separate the poles. By selecting a suitable sub-sampling factor, such as 8 or 16 before the decay rate estimation, the poles of the biosensor signal may be more readily resolved and their parameters extracted. The decay rate is then recovered by scaling the value returned from the technique by the sub-sampling factor.

The KT technique recovers only the {βₖ} in equation 5 and not the complex amplitudes {αₖ}. To recover the amplitudes, the parameter estimation technique may fit the model,

$$y ( n ) = {\sum }_{k = 1}^{M} {α}_{k} {e}^{{\hat{β}}_{k} n} , \\ n = 0 , 1 , … , N - 1 \qquad ( equation 6 )$$

to the data vector {y(n)}ₙ₌₀^{N-1}. In equation 6, {\hat{β}ₖ} are the estimated poles recovered by the KT technique. The factors {e^{\hat{β}}^{ₖ}ⁿ} now become the basis function for ŷ(n), which is parametrically defined through the complex amplitudes {αₖ} that remain to be estimated. The system may adjust the {αₖ} so that ŷ(n) is made close to the noisy signal y(n). If that sense is least squares, then the system would seek {αₖ} such that ŷ(n)−y(n)=e(n) where the perturbation {e(n)} is such that ∥e∥₂ is minimized.

This may be reformulated using matrix notion as Sx=b+e (equation 7), where the columns of S are the basis functions, x is the vector of unknown {αₖ}, b is the signal (data) vector {y(n)}, and e is the perturbation. In this form, the least squares method may be stated as determining the smallest perturbation (in the least squares sense) such that equation 7 provides an exact solution. The least squares solution, may not be the best for this setting because the basis functions contain errors due to the estimation errors in the {\hat{β}ₖ}. That is, the columns of S are perturbed from their underlying true value. This suggests that a preferred technique is a Total Least Squares reformulation (S+E)x=b+e (equation 8) where E is a perturbation matrix having the dimensions of S. In this form, the system may seek the smallest pair (E, e), such that equation 8 provides a solution. The size of the perturbation may be measured by ∥E, e∥_{F}, the Frobenius norm of the concatenated perturbation matrix. By smallest, this may be the minimum Frobenius norm. Notice that in the context of equation 1, a₁=B, and a₂=−S.

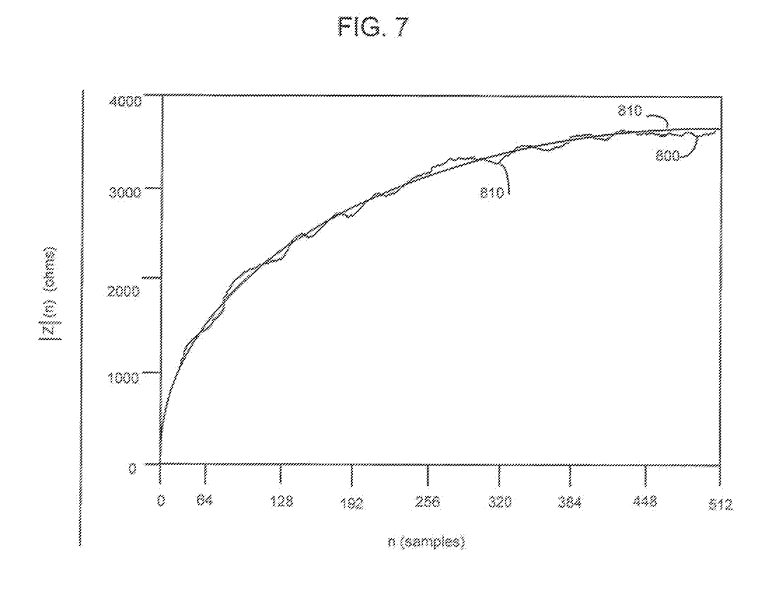

The accuracy of the model parameters, (s, A) is of interest. FIG. 7 depicts with line 800 the underlying “ground truth” signal used. It is the graph of equation 1 using values for (s, A), and B that mimic those of the acquired (noiseless) biosensor impedance response. The noisy curve 810 is the result of adding to the ground truth 800 noise whose spectrum has been shaped so that the overall signal approximates a noisy impedance signal acquired from a biosensor. The previously described estimation technique was applied to this, yielding parameter estimates (ŝ, Â), and \hat{B} from which the signal 820 of equation 1 was reconstituted. The close agreement between the curves 800 and 820 indicates the accuracy of the estimation.

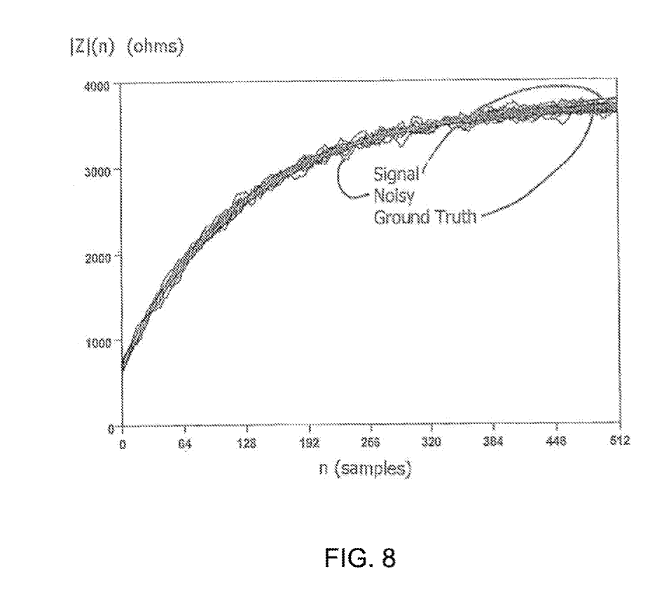

FIG. 8 illustrates applying this technique 10 times, using independent noise functions for each iteration. All the noisy impedance curves are overlaid, as well as the estimated model curves. Agreement with ground truth is good in each of these cases despite the low signal to noise ratio.

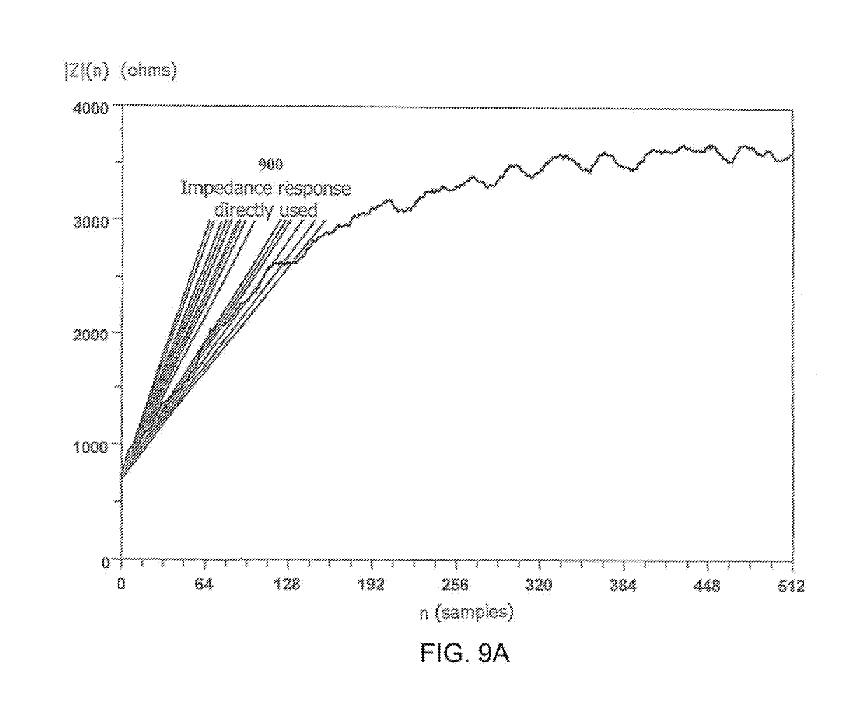

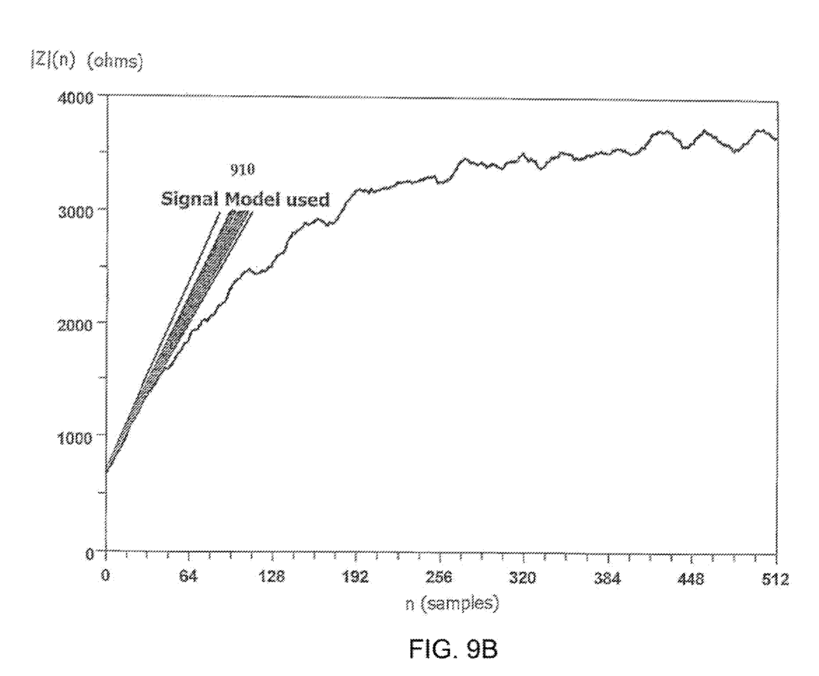

One technique to estimate the kinetic binding rate is by fitting a line to the initial portion of the impedance response. One known technique is to use a weighted line fit to the initial nine points of the curve. The underlying ground truth impedance response was that of the previous accuracy test, as was the noise. One such noisy response is shown in FIGS. 9A and 9B. Each of the 20 independent trials fitted a line directly to the noisy data 900 as shown in FIG. 9A. The large variance of the line slopes is evident. Referring to FIG. 9B, next the described improved technique was used to estimate the underlying model. Lines were then fitted to the estimated model curves using a suitable line fitting technique. The lines 910 resulting from the 20 trials has a substantial reduction in slope estimation variance. This demonstrates that the technique delivers relatively stable results.

It may be desirable to remove or otherwise reduce the effects of non-specific binding. Non-specific binding occurs when compounds present in the solution containing the specific target modules also bind to the sensor despite the fact that surface functionalisation was designed for the target. Non-specific binding tends to proceed at a different rate than specific but also tends to follow a similar model, such as the Langmuir model, when concentrations are sufficient. Therefore, another single pole, due to non-specific binding, may be present within the impedance response curve.

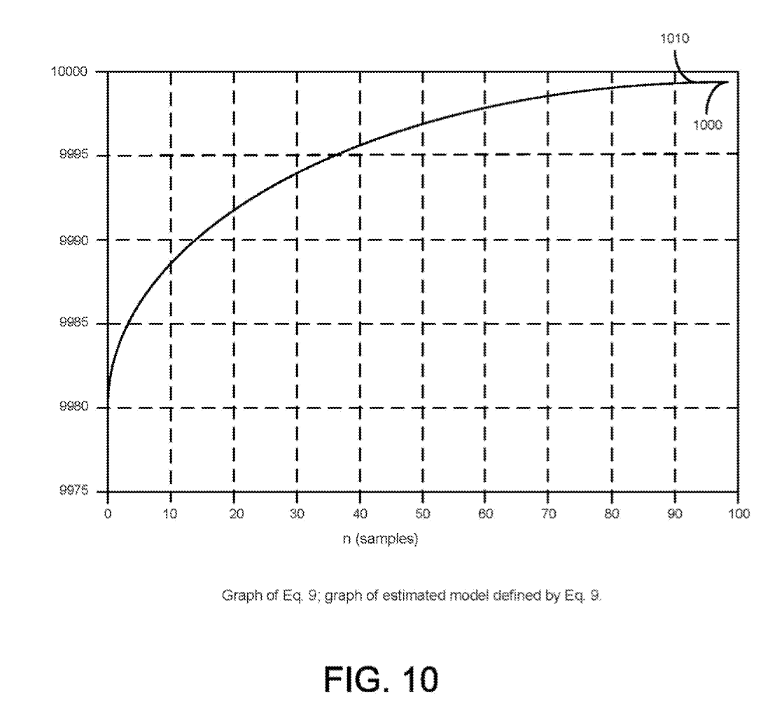

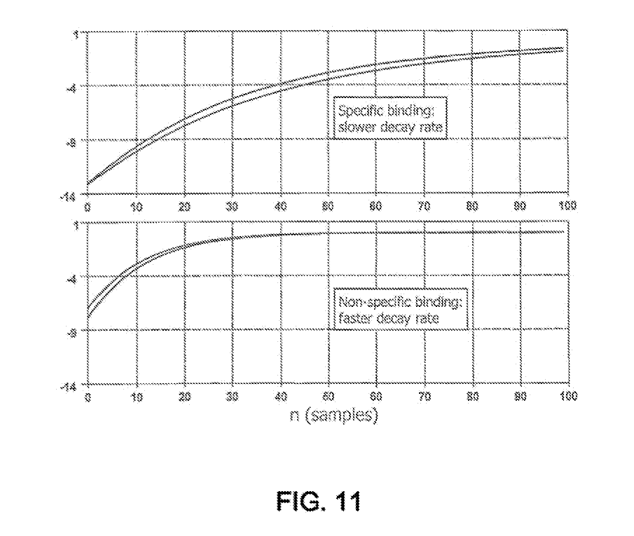

The modified KT technique has the ability to separate the component poles of a multi-pole signal This advantage may be illustrated in FIG. 10 and FIG. 11. Equation 9 describes an extended model that contains two non-trivial poles representing non-specific and specific binding responses (s₁<s₂), |Z|(n)=B−A₁e^{-s}^{₁}ⁿ−A₂e^{-s}^{₂₁}ⁿ where sₖ, Aₖ, B≧0 are constants (equation 9). Equation 9 is shown as a curve 1000 in FIG. 10 which is also close to the estimated model defined by equation 9.

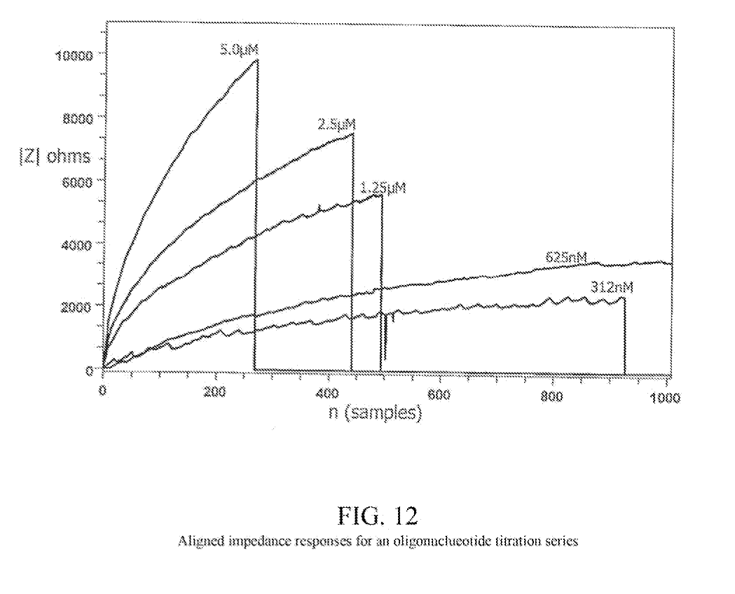

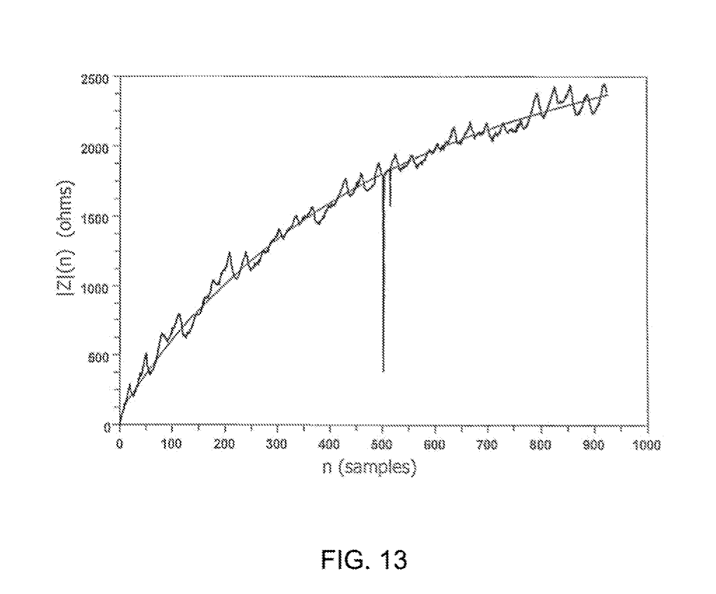

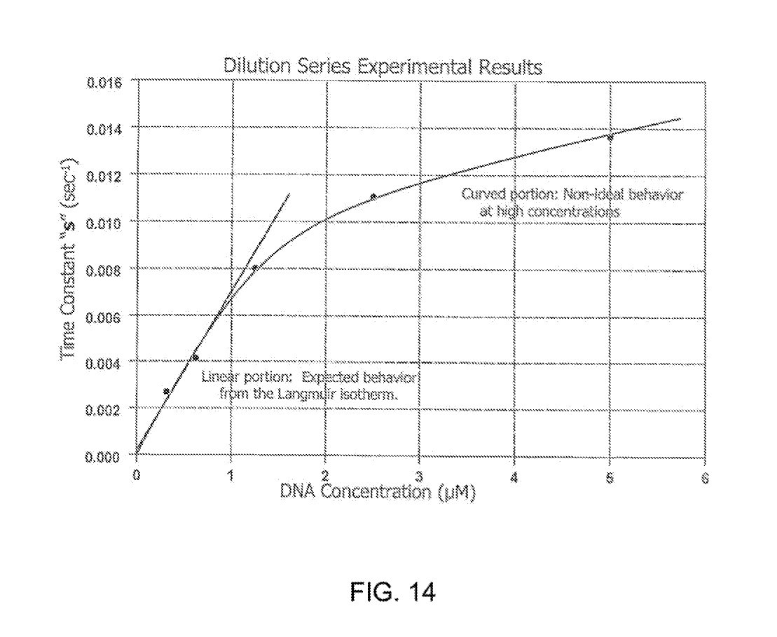

FIG. 12 illustrates the impedance responses of a titration series using oligonucleotide in PBST. The highest concentration used was 5 μM. The concentration was reduced by 50% for each successive dilution in the series. In FIG. 12, the five impedance responses have been aligned to a common origin for comparison. The meaning of the vertical axis, therefore, is impedance amplitude change from time of target injection. The response model was computed for each response individually using the disclosed estimation technique. FIG. 13 plots the lowest concentration (312.5 nM) response which also is the noisiest (s=0.002695 and A=1975.3). In addition, the estimated model curve is shown which fits the data. The results of the titration series evaluation are illustrated in FIG. 14, which at low concentrations shows a relationship close to the expected linear behavior between the decay rate and the actual concentration that is predicted by the Langmuir model. For high concentrations the estimates of rate depart from linearity. At these concentrations non-ideal behavior on the sensor surface is expected.

While decimation of the data may be useful to more readily identify the poles, this unfortunately results in a significant reduction in the amount of useful data thereby potentially reducing the accuracy of the results. Accordingly, it is desirable to reduce or otherwise eliminate the decimation of the data, while still being able to effectively distinguish the poles.

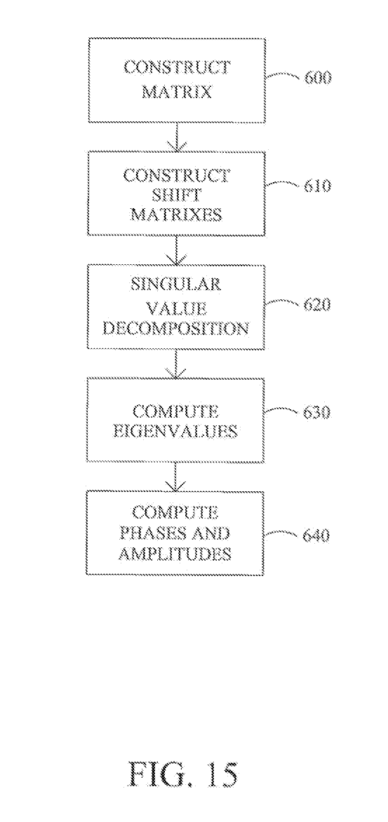

A different technique may be based upon a decimative spectral estimation. Referring to FIG. 15, the first step 600 is to construct a N−L+1×L Hankel signal observation matrix (denoted by S) of the deterministic signal of M exponentials from the N data points, where (N−D+1)/2<=L<N−M+1, and D is the decimation factor. The second step 610 includes constructing (N−L−D+1)×L matrices S^{D} (top D rows of S deleted) and S_{D} (bottom D rows of S deleted) equivalents, although in the presence of noise they are not necessarily equivalent to S. S^{D} and S_{D} are called “shift matrices”. The third step 620 includes computing a lower dimensional projection, S_{D, e} of S_{D} by performing a Singular Value Decompostion, S_{D}=UΣV, and then truncating to order M by retaining the largest M singular values. This process yields an enhanced version of S_{D} which substantially reduces the effect of the signal noise, and hence increases the accuracy of the pole estimates. The fourth step 630 includes computing matrix X=S^{D} pinv(S_{D, e}). The eigenvalues of X provide the decimated signal poles estimates, which in turn give the estimates for the damping factors and frequencies. The fifth step 640 includes computing the phases and the amplitudes. This may be performed by finding a least squares or total least squares solution, or other suitable technique. The derivation described above is for the noiseless case. In that case, the “small” singular and eigenvalues will be zero. With the addition of noise, such values are generally small.

As previously discussed, the impedance response signal is derived from the v(t) and i(t) signals. The impedance response signal may be analyzed into two (or more) unconstrained signal poles, namely, S₀ and S₁. S₀ is a pole on the unit circle which is a DC pole and S₁ is a pole off the unit circle. The phase and amplitude associated with each pole is then estimated.

The two unconstrained poles tend to be very close to one another. When the DC pole (S₀) includes an estimation error (from noise in the impedance signal), its proximity to the non-DC pole (S₁) induces a significant error into the latter, which in turn, induces an error into its associated complex amplitude estimate A₁. This inducement of error reduces the accuracy of the system.

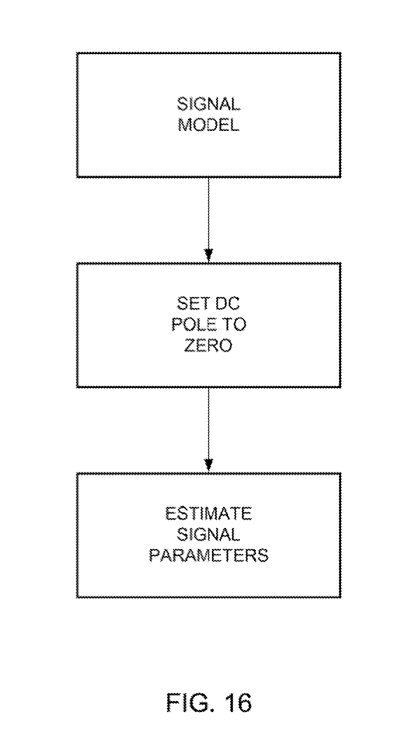

Referring to FIG. 16, based upon the signal model, a-priori knowledge exists of the DC pole, namely, that S₀=0. By using an estimation technique that allows incorporation of a-priori knowledge a constraint can be imposed so that its value is set to zero and not estimated. One suitable technique may be Constrained Hankel Singular Value Decomposition. Consequently, the influence of errors in S₀ may be removed on the estimated parameters S₁ and A₁, where A₁ is the complex amplitude associated with S₁.

In general, the extraction of the decay constants from the impedance bio signals requires a portion of the signal to be analyzed. This region of the signal that is analyzed may be referred to as the analysis aperture, which is traditionally manually defined based upon subjective judgments of an operator. As a result, different operators will tend to select different apertures for the same data and thereby obtain possibly different results based on the same signal using the same device.

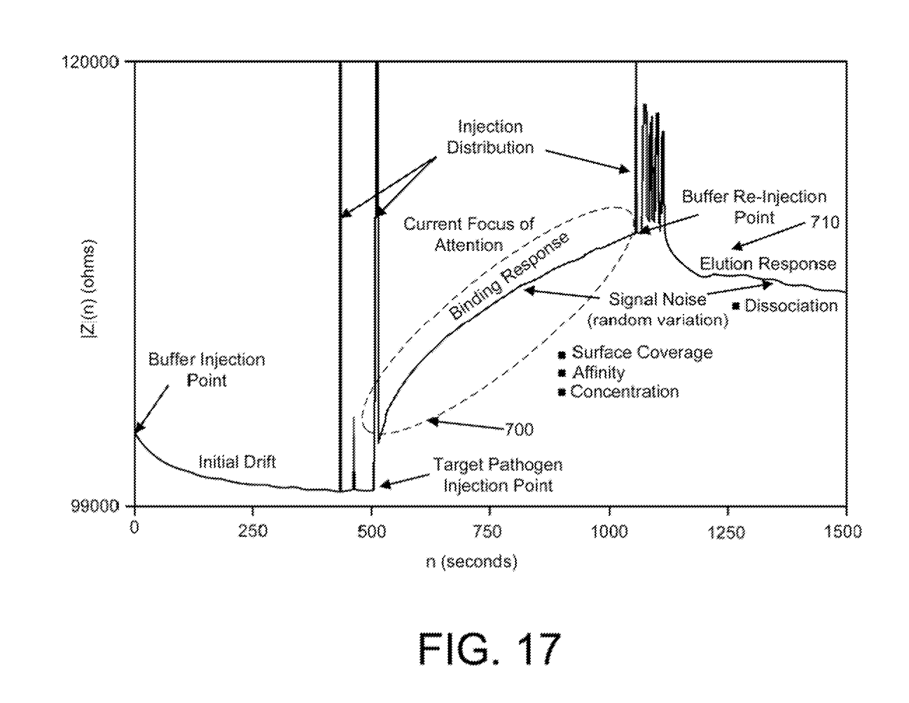

Referring to FIG. 17, an exemplary biosensor signal from an impedance analyzer is illustrated. Traditionally, a human operator manually sets the left and right endpoints of the analysis aperture in the region of interest, while attempting to avoid parts of the signal which are not part of the binding response, and hence does not obey the signal model. The left and right endpoints are typically set somewhere within the region 700 enclosed by the ellipse, or in the region 710 just following the final injection disturbance labeled elution response. As a result of noise and deviations of the signal from the signal model different choices of the endpoints will yield different signal parameter values.

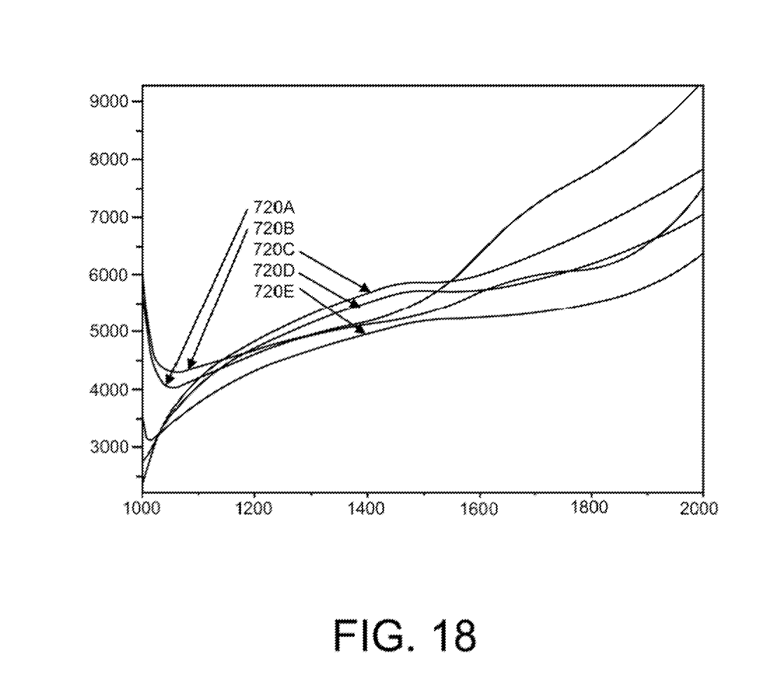

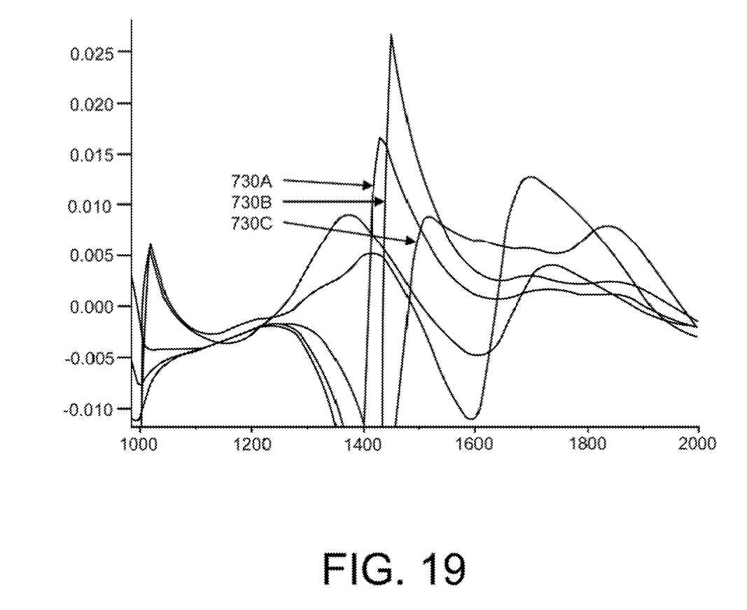

To illustrate the effect of noise and differences in the selected test aperture, reference is initially made to FIG. 18 and FIG. 19. Referring to FIG. 18, a set of five response curves 720A-720E correspond to five positive target matches within one 5-sensor test chamber. Referring to FIG. 19, a set of parameter profiles are shown based upon a short fixed width analysis aperture, i.e. a test aperture, and starting on the left side of each impedance response (see FIG. 18) to estimate the local decay constant, s₁, of each signal. The test aperture was moved one second to the right and the s₁ parameters were re-estimated. This process is repeated until the aperture reached the right end of the impedance responses. The resulting variation of the s₁ parameters comprise the plots shown in FIG. 19. Each curve shows the variation of s₁ for its corresponding impedance response. In particular, the vertical spacing between the different curves illustrates at least in part the variability in the s₁ determinations. The variations in the s₁ show that the correct aperture placement improves accuracy and repeatable bio assay results. For example, regions where the curves are close to one another in a group tend to illustrate more desirable aperture placements. To improve the accuracy and repeatability of bio-assay results it is desirable to have a system that automatically selects the analysis aperture endpoints in an objective manner. In some cases, the system may select the left endpoint, and based upon the left endpoint select the right endpoint.

Referring again to FIG. 19, the plots show the relatively large variation of the s₁ parameter with aperture placement. Similarly, variations occur in the other estimated parameters as a function of aperture width and placement. Looking at the five signals in FIG. 18 one may observe several things. First the operator would note that responses 720A, 720B are invalid signals due to their large deviation from exponential behavior and their continued drift upward. In the case of 720C, 720D, 720E, the exponential signal model is approximately obeyed from about 1100 seconds to 1450 seconds. It would therefore be in this region that the operator would subjectively define his analysis aperture. Different operators would make different judgments, thus introducing an unacceptable element of subjectivity into the assay. The effect of that subjectivity is suggested by the plots 730A, 730B, 730C on FIG. 19.

The estimated values of s₁ not only vary over a range of more than 300%, but some values—the positive ones—are “impossible” given the assumed signal model and the underlying molecular binding mechanism.

The first step to automatically determine the left endpoint is to find the general region of interest in a multi injection response. Such a response is shown in FIG. 17 where there is an injection of buffer at the beginning of the assay, followed by target pathogen injection that begins the binding response, followed by another injection of buffer in order to elicit the elution response. An annotated data format and a mechanism that automatically annotates the data at the point of each analyte injection serves to provide a technique to get near the region where left endpoint computations should begin.

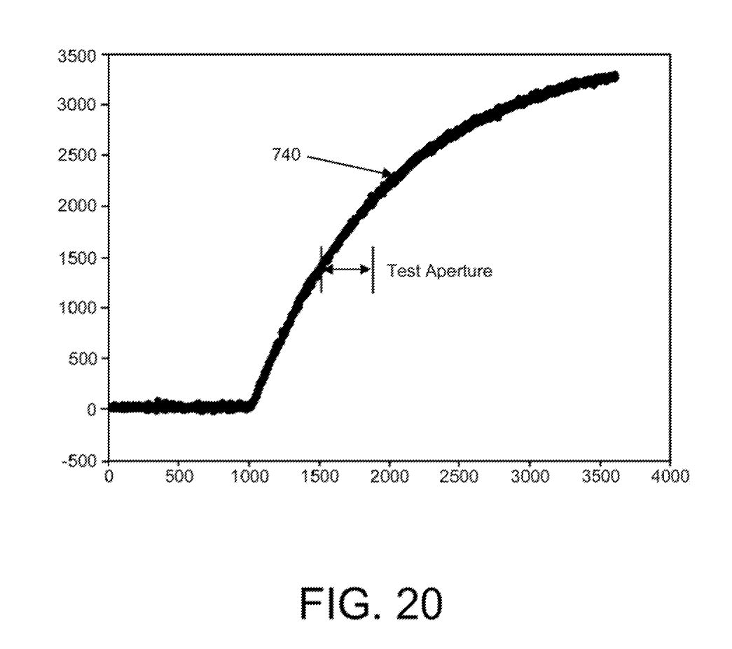

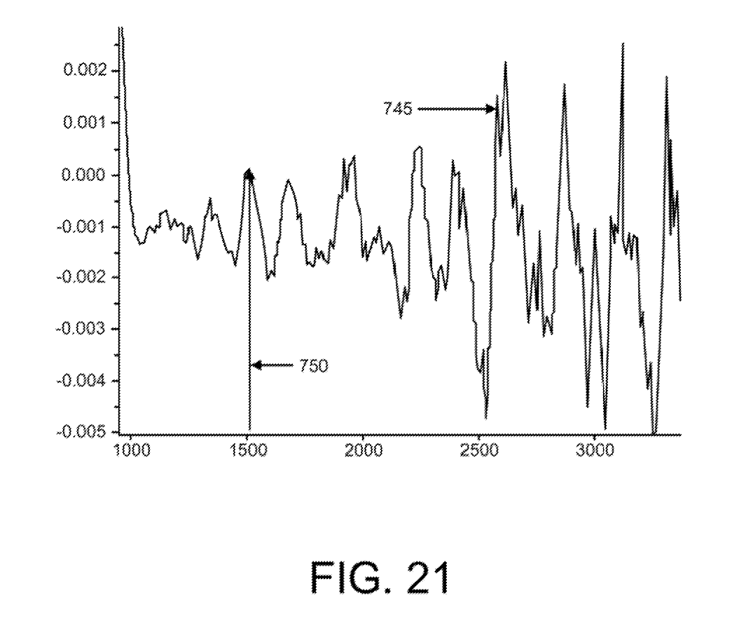

One technique to automatically determine the left endpoint is illustrated with respect to FIG. 20 which depicts five ideal noisy exponential responses 740 that obey the assumed signal model. These represent ideal positive target impedance responses from five sensor electrode pairs. FIG. 21 shows the instantaneous s₁ profile computed from one response, using a short test aperture, as previously discussed, with respect to FIGS. 18 and 19. Computation of the profile started at 1000 seconds in the impedance response. The nominal decay constant used to generate the ideal responses was −0.001 sec⁻¹, and so that it may be observed that the noisy instantaneous values of the s₁ profile illustrated in FIG. 21 vary around this nominal value. The arrow 750 shows the s₁ value that corresponds to the position of the test aperture in the left plot. The variation in the s₁ values is, in this case, due entirely to the noise component in the exponential signals. Without noise, the s₁ values would remain constant for all positions of the test aperture that are to the right of 1000 sec.

A germane feature of the s₁ profile that may be used is the increasing noise variance as one moves to the right. This can be seen in the growth of the amplitude of the deviations from the nominal value. The s₁ profiles (not shown) that correspond to the remaining four impedance responses also have the feature of increasing noise variance, although the details of the undulations differ for each profile. The system may compute the sample mean. In the following, N=5 since the computations are made across five values of s₁ at each time point, k. However one use a general expressions since using five signals is merely an example:

$$\overline{{s}_{1}} ( k ) = \frac{{\sum }_{n = 1}^{N} {s}_{1 ( k , n )}}{N} ,$$

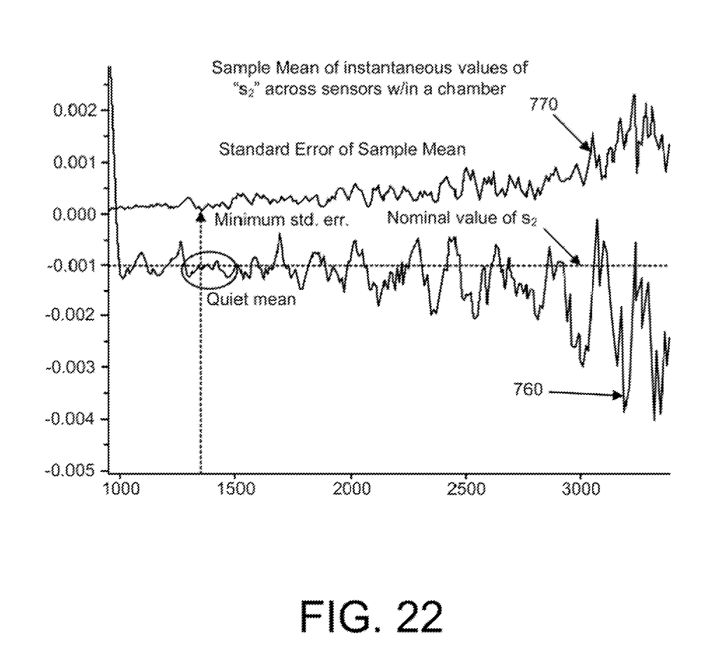

Computing across five s₁ profiles at each time point n results in the sample mean of s₁ as a function of time 760 illustrated in FIG. 22. Next, one may compute the standard error of s₁ across the profiles by,

$${SEs}_{1} ( k ) = \sqrt{\frac{{\sum }_{n = 1}^{N} {( {s}_{1} ( k , n ) - \overline{{s}_{1}} ( k ) )}^{2}}{N ( N - 1 )}} .$$

Applying this to the five s₁ profiles at each time point results in a standard error of sample mean 770. It is SEs₁(k) that is preferably used as the basis for computing the left endpoint of the analysis aperture.

The standard error, as defined by the previous equation, is a measure of the variation in s₁ across the sensors in a chamber, as a function of time. This is related to the standard deviation of the sample mean,

$${SDs}_{1} ( k ) = \sqrt{\frac{{σ}^{2} ( k )}{N}}$$

where σ⁻²(k) is the instantaneous true variance of s₁. Since the true variance of s₁ increases as a function time, as previously noted, so does SDs₁ (k), and hence so does SEs₁(k). One can therefore define,

$${k}_{0} = arg {min}_{k} {SE}_{{S}_{1}} ( k )$$

which will tend, with high probability, to be toward the left end of the signals since that is where SEs₁ tends to be the smallest. If multiple minima occur the system may select the leftmost index (earliest in time).

For real (non-ideal) acquired impedance responses, there is another factor that causes the estimated instantaneous values of s₁ to vary: deviations of the response curve from the signal model. As illustrated in FIG. 19, it may be observed that the s₁ profiles sometimes became positive, and also wandered about their nominal value in a less noisy fashion. Since positive values of s₁ are not physically allowed by the signal model, the model may be modified by adding a constraint that prohibits consideration of time indices for which s̅₁̅(k)≧0.

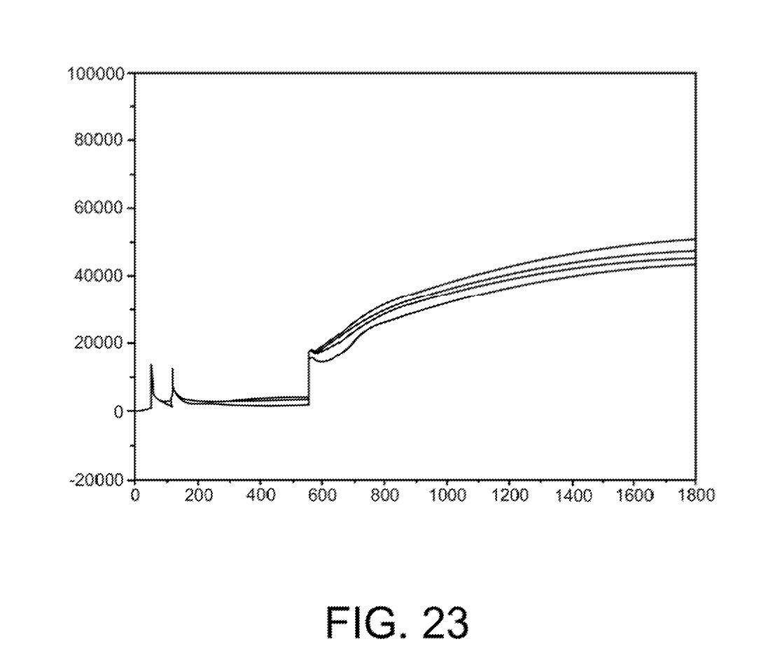

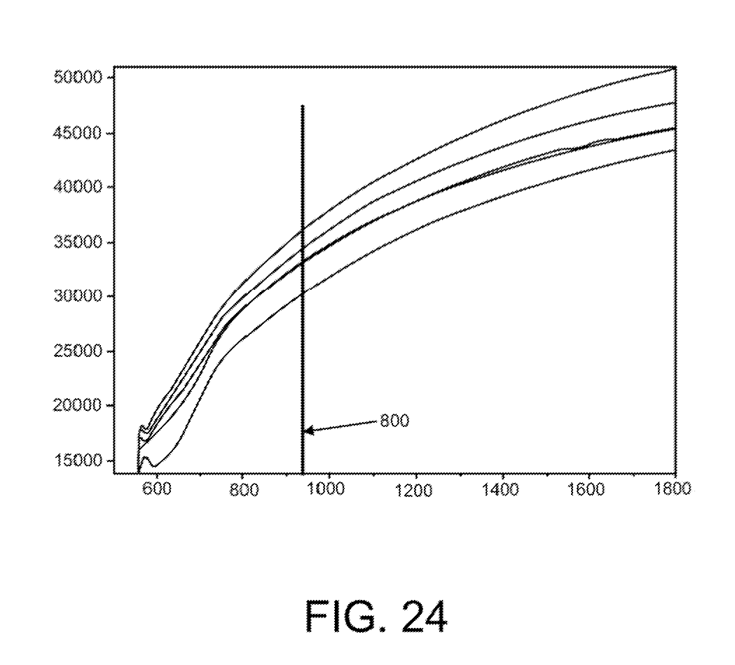

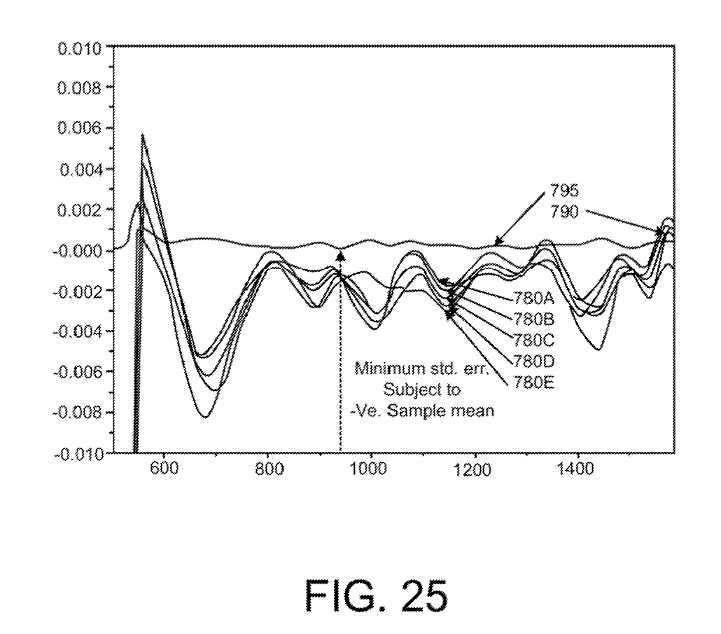

Referring to FIG. 23, the entire impedance binding responses in one chamber containing a positive target is illustrated. Referring to FIG. 24, an expanded region of interest is illustrated. None of the curves correspond precisely to an exponential. Thus, the task of the left end point computation is to find the preferred endpoint across all the available signals. Referring to FIG. 25, the functions include five s₁ profiles that correspond to the five impedance responses 780A-780E in the region of interest (from about 600 to 1600 seconds). A mean 790 of the five profiles is illustrated. A standard error function 795 SEs₁(k) is illustrated. The point kₒ, subject to the negativity constraint, occurred at about 950 seconds. This may be the left endpoint of the analysis region to be passed to the analyzer for final signal analysis. This index 800 is marked in FIG. 24.

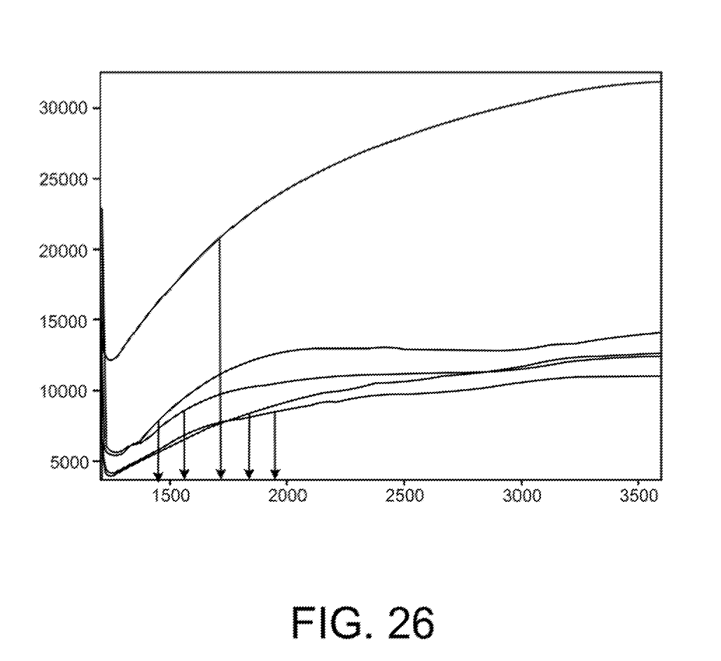

Another embodiment to determine the left endpoint includes modifying the statistical computations so that both the sample mean and the standard error are computed along a given impedance profile rather than across all impedance profiles. Other statistical techniques may likewise be used. This technique has the advantage that invalid responses do not corrupt the left endpoint calculation. This also delivers individual left endpoints for each impedance profile. Application of this technique results in five left endpoint estimations, as illustrated in FIG. 26. One of the left endpoints may be selected, or based upon a combination of estimations.

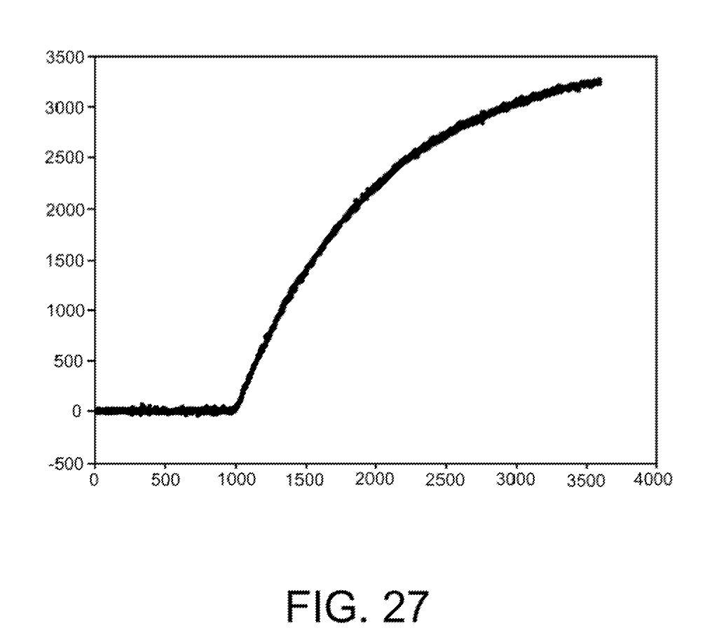

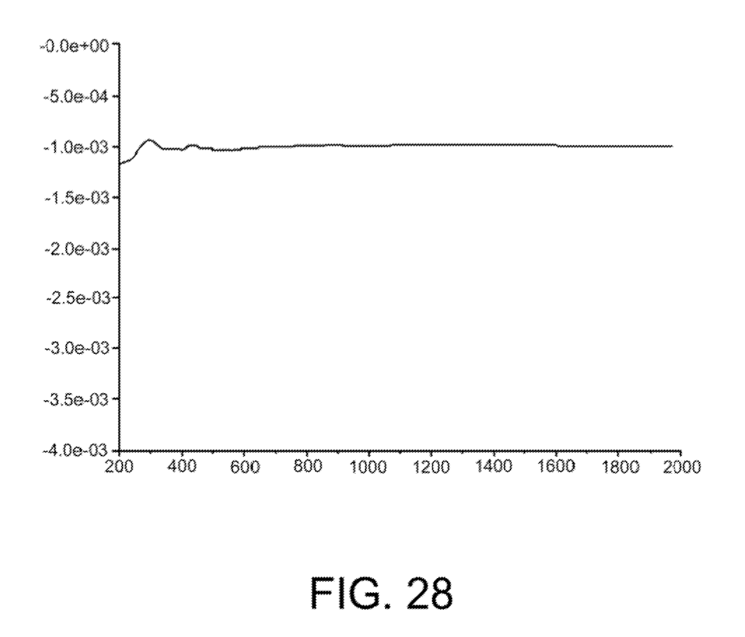

FIG. 27, illustrates the ideal impedance response while FIG. 28 illustrates the result of successively applying the parameter estimation technique to the ideal response using a left endpoint set at 1000 seconds. Focusing on the estimation of s₁, a 200 second aperture width may be used to compute a s₁ estimate. Successive estimates are computed using increasingly longer apertures, always rooted on the left side (in this case) at 1000 seconds. The horizontal axis of the right plot shows the width of the aperture used to compute the s₁ value at that point. The system may use this profile as the basis for computing a right endpoint. It is the right endpoint s₁ profile.

It is observed for the ideal case that the estimates of s₁ become constant at the nominal value after the test aperture is about 600 seconds in width. This provides motivation for using the right endpoint s₁ profile to find regions that are nearly constant (such as the first derivative being substantially zero), and of sufficient length to declare that the value s₁ is stable in that region, such as may be determined using a derivative. The system selects the rightmost index for which this characteristic exists. Any other suitable technique may be used to compute the right hand endpoint, preferably based upon the left hand endpoint.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for calculating parameters comprising:
(a) receiving a time varying voltage signal associated with a biosensor;
(b) receiving a time varying current signal associated with said biosensor;
(c) transforming said time varying voltage signal and said time varying current signal to a domain that represents complex impedance values;
(d) calculating parameters based upon said impedance values in a manner suitable to automatically select a first endpoint of an analysis aperture in a region of interest.

2. The method of claim 1 wherein said analysis aperture is substantially between injection disturbances.

3. The method of claim 2 wherein said analysis aperture is substantially in a region of binding response.

4. The method of claim 1 wherein said analysis aperture is substantially in a region of an elution response.

5. The method of claim 1 wherein said selection of said analysis aperture is based upon a decay.

6. The method of claim 1 wherein said first endpoint is a left endpoint of said analysis aperture.

7. The method of claim 6 wherein a second endpoint of said analysis aperture is based upon said first endpoint.

8. The method of claim 1 wherein said analysis aperture is based upon an increasing noise variance.

9. The method of claim 1 wherein said analysis aperture is based upon a mean determination.

10. The method of claim 1 wherein said analysis aperture is based upon an error function.

11. The method of claim 1 wherein said analysis aperture is based upon a single profile.

12. The method of claim 1 wherein said analysis aperture is based upon a plurality of profiles.

13. The method of claim 1 wherein said analysis aperture is based upon a variation as a function of time.

14. The method of claim 1 wherein said analysis aperture includes a constraint prohibiting the consideration of indices which are not physically permitted by a signal model.

15. The method of claim 1 wherein said analysis aperture is based upon a right endpoint determination based upon a substantial interval that has a derivative that is substantially zero.
